(19) United States
(12) Patent Application Publication
(10) Pub. No.: US 2026/0316342 A1
(43) Pub. Date: Oct. 15, 2026

(54) DEVICE AND METHOD FOR BREAKING DOWN COMPOSITE MATERIALS AND MIXTURES THEREOF INTO INDIVIDUAL MATERIAL COMPONENTS

(71) Applicant: COMPOSITES RECYCLING SOLUTIONS, PARIS (FR)

(72) Inventors: Christoph MUTHER, HERGISWIL (CH); Eric LOUVERT, PARIS (FR)

(73) Assignee: COMPOSITES RECYCLING SOLUTIONS, PARIS (FR)

(21) Appl. No.: 19/472,962

(22) PCT Filed: Apr. 5, 2023
(86) PCT No.: PCT/FR2023/050492

§ 371 Date: Oct. 6, 2025

(51) Int. Cl. B29B 17/02; B02C 13/18; B29B 17/04

(52) U.S. Cl. CPC B29B 17/02; B02C 13/18; B29B 17/0412; B29B 2017/0231; B29B 2017/0244

(57) ABSTRACT

The present invention relates to a device and a method for the decomposition of composite materials and also of form-fitting structures containing composite materials, and of mixtures thereof. The tribomechanical and mechanochemical treatment of the aforementioned materials in a reactor (1) under the action of a fluid composed of a gas and a liquid makes it possible to deform the composite materials selectively due to their physical differences.

The present invention relates to both a device and a method for breaking down composite materials and mixtures into individual material components. In particular, the present invention relates to a device according to the preamble of claim 1, as known, for example, from WO2017/036534 A1.

Such devices and methods are used for the breakdown of composite materials as well as interlocking structures containing composite materials, and mixtures thereof, by means of tribomechanical and mechanochemical treatment, whereby a reshaping action acting on the breakdown of a material stream composed of the composite materials takes place selectively inside a reactor by utilizing the physical differences between the various particles in the material stream. The breakdown is effected by thrust forces between the layers, along the phase boundaries of the meeting regions of different composite materials.

Due to the complexity of their structure, many materials can only be recycled to a limited extent. Composite materials and their mixtures, in particular, represent a challenge. As they have become an integral part of our daily lives, it is necessary to propose solutions for the material recycling of composite materials and material mixtures.

The fact that new materials are added every day to the already known materials makes the constant development of new material recovery solutions necessary, which on the one hand allow the separation of the different materials and on the other hand avoid the production of polluting waste or gases (CO2, NOX, . . . ).

These composite materials are sometimes form-locked to other composite materials and are therefore difficult to separate.

Furthermore, these complex material compositions often prevent the use of conventional methods such as thermal treatment or treatment with liquid chemicals.

Electronic waste, in particular, constitutes such a very complex type of waste, for which it is difficult to break down the different components of the composite material.

Besides printed circuit boards composed of composite materials, electronic waste, such as that illustrated for example in FIG. 1, also includes a large number of form-locking components, like housings, connectors, etc.

Other typical wastes, which are difficult to access for material recycling, are packaging composites made of PE and aluminum in the form of a three-layer laminate, as shown in FIG. 2. The aluminum serves as a barrier against light and is used to protect a product wrapped in this laminate against diffusion. Most of the time, the aluminum layer is located between two plastic layers or is laminated on both sides. The aluminum layer is between 6 and 80 μm thick, depending on the application.

As another example of known composite materials, FIG. 3 schematically shows a printed circuit on a circuit board. Such printed circuit boards are composed of up to more than 50 layers of copper and glass fiber epoxy resins (FR4), which serve as an electrical conductor (copper) or an insulator (glass fiber epoxy). These copper layers have a thickness between 17 and 34 μm. The thickness of the glass fiber epoxy resin layer is greater than 50 μm.

Furthermore, the contact points can be provided with precious metals, notably gold. The layer thicknesses, however, are only a few um.

FIG. 4 shows a sandwich panel as used for cladding, notably in façade or vehicle construction. The material is durable and light. The thickness of the metal layer, for example aluminum, on the outer faces is between 100 and 300 μm, that of the plastic core material is about 2 to 4 mm.

These composite materials pose problems after their use, when these materials are taken off the market and thus become waste. It is well known that the production of these composite materials can already generate considerable quantities of waste.

Thus, the manufacture of printed circuit boards generates up to 20% of production waste during the manufacturing process.

The manufacture of packaging composites, such as tube laminates, generates even up to 30% of production waste.

It emerges from literature that, relative to the quantity of metals used, for example aluminum, only about one third finds its way back into the economic cycle. For more expensive metals, such as copper, this figure is about 50%. This is explained by the fact that, on the one hand, the collection logistics and, on the other hand, the methods for separating the different substances from the composite materials are lacking or too expensive.

The complexity of these materials generally does not allow for their mechanical recycling back to the starting raw materials, which is why these potential sources of raw materials are removed from the economic cycles. The associated environmental costs are doubly problematic. On the one hand, the production of new materials generates additional environmental pollution from ore smelting and, on the other hand, from the transport of waste that cannot be used as raw materials.

Furthermore, enormous quantities of energy are required for the primary extraction of raw materials, especially metals, which could have been saved within a consistent circular economy.

Studies have shown that a consistent circular economy alone could save about 20% of the energy produced worldwide.

The materials that are currently processed using inefficient thermal or wet-chemical processes are generally of inferior quality and cause considerable environmental pollution from harmful residues and relatively high emissions of polluting gases, sludges, waste water, and slags.

In the device described in WO 2017/036534 A1 and shown in FIG. 8 (reactor 1), it has proven to be inefficient and producing an insufficient effect at the cost of considerable wear. This is primarily linked to the poor feeding of the material to be broken down into an annular space 10 (FIG. 9) inside the reactor and the absence of preconditioning of the material to be treated. In this known device, the mixture to be broken down falls directly via a funnel-shaped material inlet (feed hopper) onto a rotatable rotor 3 and is propelled above the annular space 10 against the housing of a stationary stator 2. Only then does the material to be delaminated arrive in the mechanical engagement area between the rotor tools 6 and the stator tools 7, the feeding into the annular space 10 being uncontrolled and chaotic. When wear occurs on the rotor 3 and stator 2, and in particular on the rotor tools 6 and stator tools 7, the conditions necessary for digestion cannot be maintained continuously in the reactor 1, as no fluid adapted to the current state of wear is supplied. The ambient air supplied to the reactor 1 in the prior art is a random result that reflects the conditions existing at that time in the machine hall where the reactor 1 shown in FIG. 8 is installed and used.

The aim of the present invention is therefore to improve the device known from the prior art in such a way as to enable a more efficient and environmentally friendly separation of composite materials and substance mixtures, while increasing the service life of such a device and providing measures to achieve as uniform and reliable a breakdown as possible of the composite materials to be separated in such a device, over the entire service life of the device and despite wear due to operating time, and for the widest possible range of differently composed composite materials.

According to the invention, this problem is solved by a device according to claim 1 and a method according to claim 11. The other claims relate to advantageous embodiments of such devices and methods.

Advantages and features of the present invention emerge in particular from the following detailed description of preferred embodiments in conjunction with the accompanying figures.

### THE FIGURES

FIG. 1 a schematic representation of electronic waste;

FIG. 2 a packaging composite known from the prior art;

FIG. 3 a laminated composite material known from the prior art, which comprises metal layers and a glass fiber epoxy layer;

FIG. 4 another laminated composite material known from the prior art, such as used for example in façade or vehicle construction;

FIG. 5 a two-axis plate crusher, as can be used in a preferred embodiment of a device according to the invention for breaking up composite materials before their introduction into the interior of the reactor of a device according to the invention;

FIG. 6 a schematic diagram of the different steps of a preferred embodiment of a method according to the invention for breaking down composite materials in a device according to the invention illustrated in FIG. 7;

FIG. 7 an embodiment of a device (reactor) according to the invention, which can be continuously filled with a mixture of gas, liquid, and composite materials to be treated, in order to allow the continuous implementation of a method according to the invention;

FIG. 8 a device (reactor) known from WO2017/036534 A1 for breaking down composite materials; and

FIG. 9 a detailed view of an annular space inside a reactor illustrated in FIG. 7 or 8, the annular space being formed between a rotor and a stator where the rotor tools and stator tools can act together on composite material components in a material stream to be brought to the reactor.

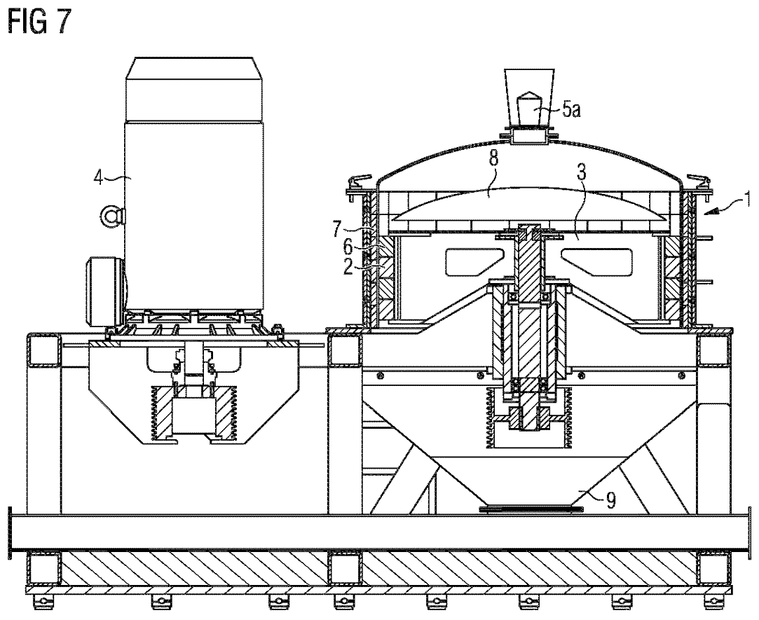

A preferred embodiment of a device according to the invention (reactor 1) for separating composite materials and mixtures is represented in FIG. 7.

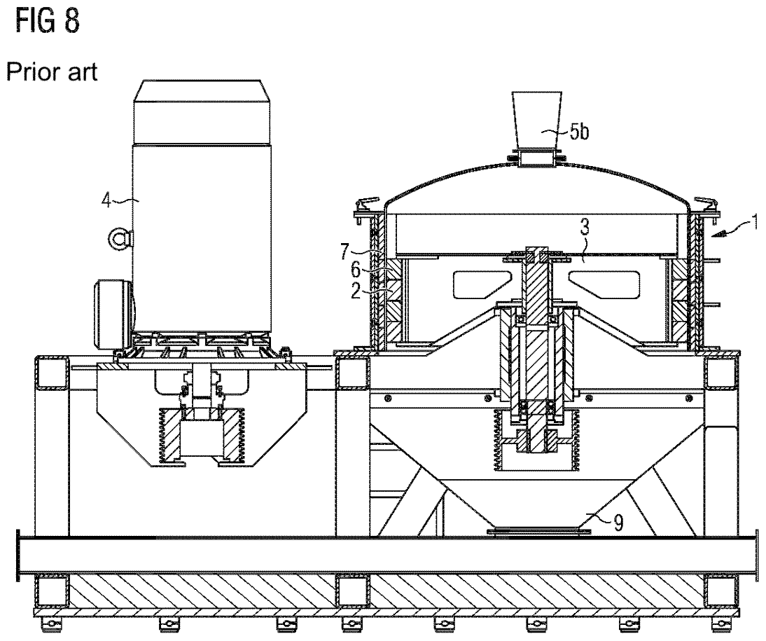

As with the known device illustrated in FIG. 8, the preferred embodiment of a device according to the invention (reactor 1) illustrated in FIG. 7 comprises a drive unit 4 for driving a rotor 3 which is connected to a bearing/shaft unit which preferably has an axis of rotation oriented substantially parallel to the earth's gravitational force.

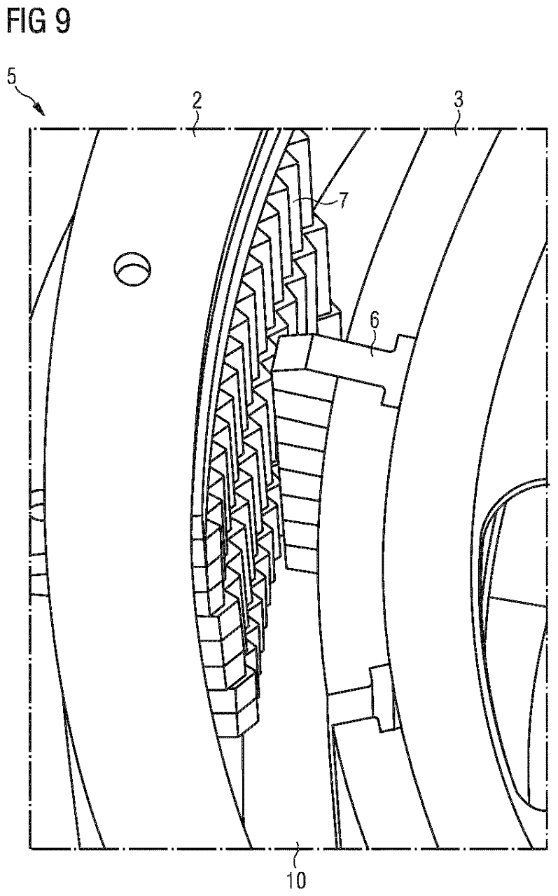

In the reactor 1 represented in FIGS. 7 and 8, the rotor 3 comprises at least one rotor tool 6 (FIG. 9). The rotatable rotor 3 is surrounded by a stationary stator 2, which in turn has stator tools 7 (FIG. 9) oriented towards an annular space 10 (FIG. 9). In another embodiment (not represented), a rotor can also surround a stator.

The rotor 3 and the stator 2 are preferably of substantially cylindrical shape inside the reactor 1. However, depending on the type and composition of the material stream to be broken up, shapes other than cylindrical can also be used for the rotor 3 and stator 2.

In the known device illustrated in FIG. 8 (reactor 1), it comprises a material inlet in the form of a simple feed hopper 5b through which the material stream to be brought to the reactor 1 falls into the interior of the reactor 1. When the material to be separated is fed from above the rotor 3 and the stator 2, in the known device illustrated in FIG. 8, it arrives in an uncontrolled manner into the annular area 10 (FIG. 9), where it is crushed between the rotor tools 6 and the stator tools 7, and from where it then reaches a material outlet 9 located below the rotor 3 and the stator 2.

In contrast, in the device according to the invention illustrated in FIG. 7, the material inlet is made in the form of an injector-mixer 5a. This allows a metered supply of pretreated material in the material stream to be fed, in particular broken material, into the interior of the reactor 1. Furthermore, the injector-mixer 5a allows variable metering of a working fluid which can be mixed into the material stream to be broken up in the injector-mixer 5a under conditions that can vary over time.

Furthermore, in the device according to the invention, a curved disc 8 is placed between the injector-mixer 5a on the one hand and the rotor 3 and stator 2 on the other hand inside the reactor 1, in order to deflect in a targeted manner a stream of composite material to be broken up, to be fed to the injector-mixer 5a, into the engagement area in the annular space 10 (FIG. 9) between the rotor tools 6 and the stator tools 7.

The disc 8 is concave relative to a material stream introduced from above into the interior of the reactor 1 by the injector-mixer 5a. This ensures that fragments of the material stream brought inside the reactor 1 by the injector-mixer 5a and to be further broken down there are directed in a targeted manner on the surface of the curved disc 8 into the annular engagement area (annular area 10) between the rotor tools 6 and the stator tools 7. The curved disc 8 thus allows the material stream to be broken up inside the reactor 1 to be directed in a targeted manner towards the area where the rotor tools 6 and the stator tools 7 can deploy their desired mechanical crushing work directly and without detour on the fragments fed from outside in the material stream to be broken up. This increases the efficiency with which the fed material stream is broken apart. Furthermore, unnecessary wear of parts inside the reactor 1, which are exposed to a chaotic influx of materials in the prior art, is avoided.

In a particularly preferred embodiment of the device according to the invention, it is further provided, for additional fine-tuning, that the curved disc 8 inside the reactor 1 is adjustable in the direction of the axis of rotation of the rotor 3. This allows optimal adjustment of the distance of the curved disc 8 both relative to the injector-mixer 5a and relative to the rotor 3 and the stator 2 in the vertical direction. This allows further optimization of the targeted deflection of the material stream introduced inside the reactor 1 by the injector-mixer 5a into the engagement area between the rotor tools 6 and the stator tools 7. Such an adjustment of the distance between the curved disc 8 and the injector-mixer 5a or the rotor 3 and the stator 2 can also be carried out in response to any blunting of the rotor tools 6 and stator tools 7 over time.

This overcomes the disadvantages encountered with the device of the prior art regarding the wear of the rotor and stator tools 6, 7 and insufficient yield during the continued breaking apart of the fragments inside the reactor 1. In the injector-mixer 5a, the device according to the invention (reactor 1) illustrated in FIG. 7 allows a gas-liquid mixture (fluid) to be applied to the material stream to be fed and broken up, with which the fluid mixes intensively. In another particularly preferred embodiment of the device according to the invention, which is used in particular for pre-crushing electronic waste as illustrated in FIG. 1, a pre-crushing of the material stream of composite materials (in particular electronic waste components) to be subsequently fed to the injector-mixer 5a is performed by means of a new two- or three-axis plate crusher, as represented in FIG. 5. Unlike conventional plate crushers, this new plate crusher operates in two or three directions (axes).

The exemplary embodiment illustrated in FIG. 5 shows a two-axis plate crusher. Such a new type of plate crusher causes, by alternating pressure exerted on the material to be opened from directions substantially perpendicular to each other, it to be broken down into individual components and the interlocking structures in the material stream to be cancelled. This allows certain individual components to be selected before the actual introduction of the material stream into the interior of the reactor 1 of the device according to the invention (reactor 1) and, if necessary, enables pre-separation of any broken components before they enter the interior of the reactor 1.

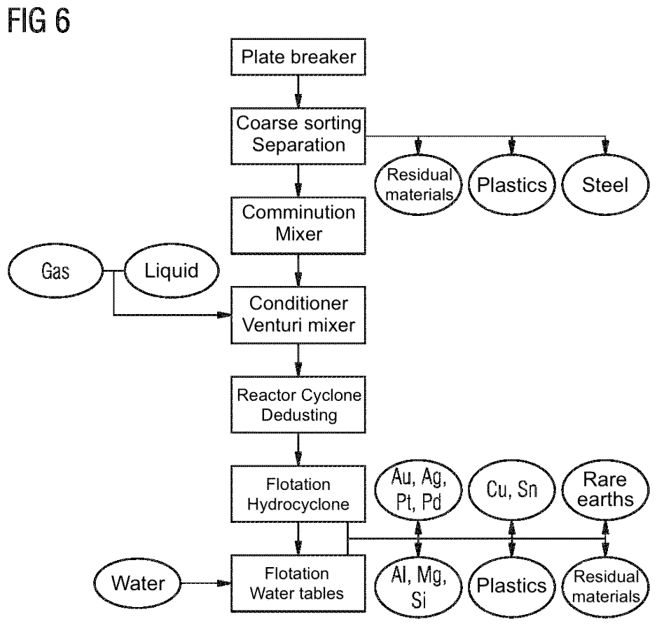

In another particularly preferred embodiment of a device according to the invention, other means for pre-sorting fragments from the material stream to be fed into the injector-mixer 5a can be connected between the plate crusher and the injector-mixer 5a, in the form notably of lifting magnets, induction separators and/or multi-sensor separators. These allow coarse sorting/separation of components, in particular magnetic or magnetizable, as well as certain plastic components from the material stream to be fed, as illustrated in the block diagram of an embodiment of a method according to the invention in FIG. 6. The advantages of such a procedure are obvious: a significant part of the material can thus be extracted from a material stream to be fed to the reactor 1 with minimal effort even before it enters the interior of the reactor 1, so that the reactor 1 is unloaded.

Furthermore, in another preferred embodiment of the present invention, other means serving for comminution can be connected between the lifting magnets, induction separators and/or multi-sensor separators on the one hand and the injector-mixer 5a on the other hand. These other comminution means can notably be shredders, hammer mills and/or granulators designed to comminute and homogeneously mix further fragments from the material stream to be conveyed to the reactor 1 to a size of <15 mm. They allow further comminution and mixing, as illustrated in the block diagram of an embodiment of a method according to the invention in FIG. 6, of the particles in the material stream which are introduced into the reactor 1 of a device according to the invention by the injector-mixer 5a.

After this optional pre-crushing and intermediate separation in the steps “plate crusher”, “coarse sorting” and “comminution/mixer” in FIG. 6, the material stream to be broken up is fed to the reactor 1 according to the invention (FIG. 7) with the addition of a gas-liquid mixture (fluid) in the injector-mixer 5a for the actual breaking apart in the reactor 1.

But if the material stream to be broken up has a suitable composition from the start (for example, in the case of soft plastic composite films which do not have to be broken in a plate crusher, which cannot be influenced by lifting magnets, and which could not be crushed by hammer mills), these optional steps of pre-crushing and intermediate separation can be completely or at least partially omitted. The optional steps “plate crusher”, “coarse sorting/separation” and “comminution/mixer” in FIG. 6 are therefore installed or omitted upstream of a reactor 1 according to the invention, depending on the starting materials to be processed.

From the prior art according to WO2017/036534 A1, it is only known that the material is fed to the reactor 1 via a feed hopper 5b (FIG. 8) in the presence of ambient air. However, according to the invention, a significant improvement in the mode of action of such a reactor 1 during the breakdown of composite materials can be obtained by a suitable addition of a fluid under conditions specifically adapted to the materials to be broken down, since a targeted tribomechanical and mechanochemical action of the fluid on the composite materials to be broken down can thus be achieved.

Particularly preferred process parameters for the fluid used in the injector-mixer 5a according to the invention are as follows:

The inlet temperature of the liquid to be mixed into the fluid is:
between 5 and 25 °C for water,
between −250 and −200 °C for liquid nitrogen used notably for a desired chemical inerting inside the reactor 1, and
between 10 and 30 °C for oil.

The inlet temperature of the gases to be mixed into the fluid is:
between 10 and 30 °C for ambient air, and
between 5 and 25 °C for argon.

The aforementioned liquids are fed to the injector-mixer 5a at atmospheric pressure and the aforementioned gases at 500-800 kPa with the addition of the solid matter of the material stream to be broken up. The density of the fluid can then be considerably influenced by an increased proportion of liquid or gas. The thermal energy generated by friction during the process is efficiently dissipated, favored by the liquid content. An increased density of the fluid leads to a longer dwell time of the solid material (composite material to be broken down in the material stream to be fed) in the annular space 10 inside the reactor 1. Furthermore, an increased proportion of liquid leads to an equalization of the electrostatic potential between the particles in the material stream, which prevents an electrostatic charging of the particles.

This differs from the prior art as described in WO 2017/036534A1.

Furthermore, after the material leaves the inside of the reactor 1 in the main stream through the material outlet 9, further separation of the broken down components can optionally be performed on water separation tables, hydrocyclones and flotation or sedimentation tanks or in filters. This is illustrated in FIG. 6. The mixture discharged from an optionally connected cyclone or filter can be wetted with water in the material stream to be discharged from the interior of the reactor 1, immediately after leaving the interior of the reactor 1, by an optional Venturi nozzle. This has the decisive advantage of preventing any dust formation and capturing all structures, even the finest, such as precious metals or rare earth metals.

In order to utilize these composite materials or to exploit them as a source of raw materials, these composite materials are subjected to a mechanical post-treatment process, preferably according to the invention. The purpose of the invention is to break down and then separate the different materials in a material stream to be fed by means of the device (reactor 1) illustrated in FIG. 7. In a preferred embodiment of a method according to the invention for operating the device according to the invention, this can be done for example in five process steps, as illustrated schematically in FIG. 6:
1. The breakdown of the structures, for example computer housings, is carried out by means of a plate crusher (FIG. 5) which exerts alternating pressure from two (possibly three) moving plates on the opposing fixed plates. The applied forces acting on the computer housings cause the destruction or fragmentation of the structure or the form-locked joint. The housings and internal structures are then reduced to pieces and can subsequently be removed from the inside of the plate crusher by means of a scraper.
2. Separation or coarse sorting of the materials. The now exposed materials, such as plastics, printed circuit boards, sheet metal parts, etc. The steel housings, or more generally the ferromagnetic parts of the material stream to be separated, are removed by means of a lifting magnet. The plastic components and Fe-Cu components (transformers, motors, etc.) are separated by induction separators or multi-sensor separators. The remainder, consisting of composite materials such as printed circuit boards, connectors, cables, etc., is fed to the next process step.
3. The remaining partial stream is then subjected to classic mechanical comminution in shredders, hammer mills, granulators, etc. and processed to a size of <15 mm, for example. The material is mixed homogeneously and prepared for further processing.
4. The material is then metered by adding a fluid (gas/liquid mixture) into the reactor 1 in the device according to the invention via the injector-mixer 5a, preferably at the pressures and temperatures indicated above. The actual breakdown of the composite materials into different material qualities takes place in the reactor 1. These are discharged and extracted pneumatically (i.e., by a suction system) from the reactor 1. The process is described in more detail below. Then, the mixture and the fluid are separated in cyclones and filter systems optionally connected downstream of the reactor 1 in the material stream to be discharged. Alternatively, the mixture can be homogenized in the form of a suspension with the addition of further liquid in a Venturi mixer (not shown) optionally installed in the material stream to be discharged downstream of the reactor 1 and added directly by pumps (not shown) to the density separation.
5. The mixture is then separated by density separation with the addition of another liquid. Flotation tanks, hydrocyclones and water separation tables can be used for this. In the flotation tanks (usually filled with water), substances with a density <1 g/cm³ are extracted as the non-settleable part. These are thermoplastics and other organic substances. The heavier plastics with a density >1 g/cm³ are fed together with the minerals and metals as sediment by means of a suspension into the optionally connected water separation tables or hydrocyclones to be discharged from the reactor 1. There, a separation can be performed into plastics, aluminum and other light metals, copper and copper alloys, precious metals and enriched rare earth metals. The separation is based on the presence of different densities of the materials to be broken down and the different mobilities of their particles in fluids. For this, a vibratory excitation of the inclined plane of a water separation table is used, which utilizes the different conveying behavior of the different materials. The particles of the different composite materials exhibit, due to their different densities and particle sizes, different mobilities relative to each other in an ambient liquid; this leads, during the vibratory excitation of the water separation tables, to a separation of the particle types on a water separation table. The discharge is then done via water-bearing chutes, which are arranged and designed in different ways. The material is then dried if necessary. The above steps 1) to 5) preferably relate to materials originating from electrical and electronic waste (FIG. 1).

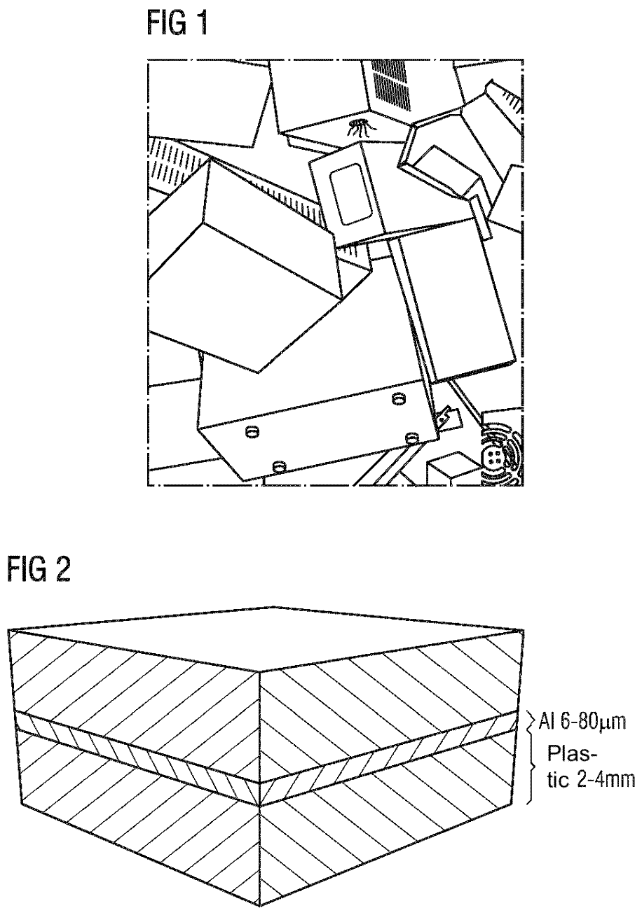

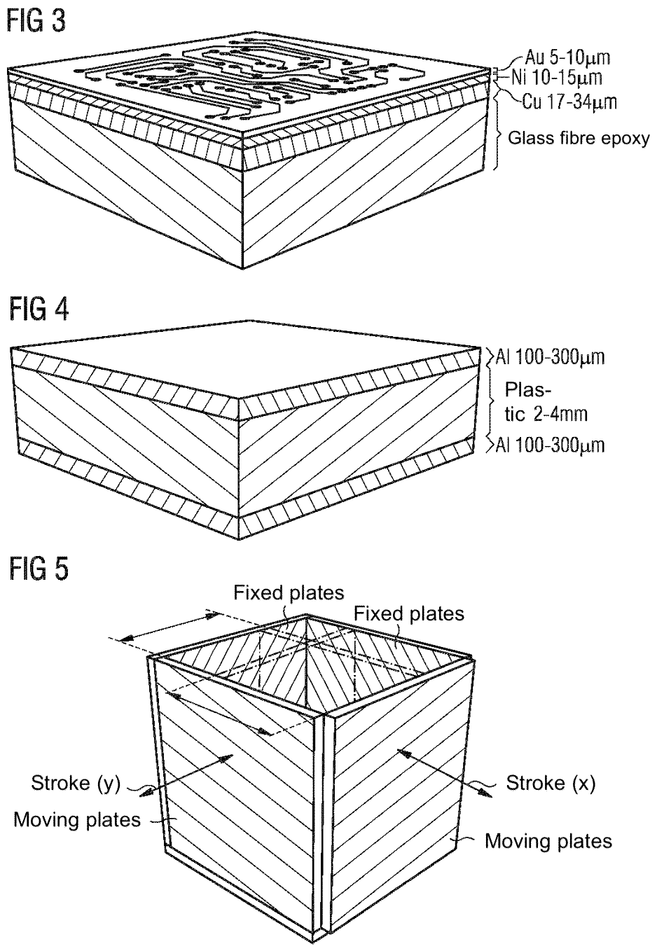

Materials that are not form-locked (FIGS. 2 to 4) generally do not require process steps 1 and 2. In this case, the process preferably only begins with the comminution in process step 3).

If the input material to be treated consists of a mixture with a size <15 mm, process step 3) is also not required, as the material can in this case be introduced directly into the reactor.

FIG. 6 shows a schematic overview of the individual stations or components that occur in an inventive device and in an inventive method.

As shown in FIG. 6, the physical differences of the materials (composite elements) present in the composite material are used to break it down. These physical differences naturally appear at the boundary layers, i.e., where one material is distinguished from a neighboring material.

The differences between the physical properties of the different materials, notably density, elasticity, ductility and vibration absorption, are reinforced by the addition of additives, in particular water and gas, preferably also conditioned ambient air. Furthermore, the heat produced during the process is dissipated by utilizing the liquid or water content contained in the fluid. The mechanical stress on the composite material leads to a layer-by-layer detachment (delamination) of the materials by deformation, which also varies due to the different elastic recovery behavior of the composite materials. Moreover, the gas-liquid mixture (fluid) which is brought to the device in the injector-mixer 5a promotes the breakdown of the elastic parts such as plastics, rubber, etc. by an increased absorption of the vibrations that occur.

It is not a question of crushing or pulverizing.

The differences in the yield strengths and elasticities of the composite elements ultimately lead to a rupture of the composite at the contact surfaces.

Contrary to WO 2017/036534A1, the feeding of the material to be processed is done via an injector-mixer 5a, such as for example a Venturi mixer, in which a gas-liquid mixture is mixed with the solid material to be processed (composite material particles in the material stream to be fed). Depending on the application, the fluid can preferably be air and water or, in an application requiring inerting, nitrogen or argon can also be added. Likewise, it has been shown that a mixture, for example of lime and wood flour, can be added by adding solid additives to absorb oils or lithium. This on the one hand prevents oxidation and on the other hand allows the mixture to be discharged in a solid form.

In case of wear on the rotor 3 or stator 2 in the reactor 1, adaptations of the fluid are performed in order to maintain the parameters necessary for mineralization. The wear on the rotor 3 and stator 2 considerably increases the flow velocity of the material through the annular space 10 and thus reduces the dwell time in the reactor 1, which prevents a satisfactory mineralization of the material. In contrast, if the density of the fluid is increased, a longer dwell time in the annular space 10 is obtained, which again ensures a satisfactory digestion of the material.

It is therefore evident that the availability of the installation is considerably improved.

Thanks to the controlled feeding of the solid-fluid mixture by the curved, optionally vertically adjustable disc 8 (FIG. 7), the mixture is brought directly into the annular space 10 (FIG. 9), without bouncing against the stator 2 in front of the annular space 10. The entry into the annular space 10, where the breaking apart of the material takes place, can thus be done in a controlled manner with constant parameters. Furthermore, wear is considerably reduced, particularly in front of the entry zone of the material into the annular space 10. Another effect is a higher throughput in the device, as there are no longer losses due to an uncontrolled feeding of the material.

To obtain these breaking apart effects, a device (reactor 1) is required, as illustrated in FIG. 7, which is continuously filled with a mixture of gas, liquid and the composite material to be treated. This material stream to be fed is mixed or preconditioned just before the reactor 1.

It has been shown that this mixture should preferably be supplied in a ratio of the following volume units, respectively the following proportions:
2 to 5 volume units of solid (composite material), 1.2 to 1.5 volume units of liquid (preferably water) and 5000 to 12000 volume units of gas (preferably conditioned ambient air)

This mixture is fed into the reactor 1, which consists of a rotating part (rotor 3) and a fixed part (stator 2). It has been shown that the arrangement of the axes (horizontal or vertical) is not of decisive importance for the actual process of breaking down the material. However, for optimum feeding, it has proven practical in practice to feed the material/gas/liquid mixture from the top to a vertically arranged device (reactor).

The material to be treated (input) is subjected to an enormous particle acceleration, which brings into play mechanochemical (i.e., generated by the action of the fluid or the components contained in the fluid) and tribomechanical (i.e., generated by the high-frequency, reciprocal inverse thrusts described below) effects, which subsequently lead to the breaking apart or detachment of the different layers.

This process of particle acceleration repeats at high frequency, creating a thrust between the layers, along the phase boundaries, which continues interactively in all directions (axes). (Thrust—Thrust reversal—Thrust— . . .). This particle acceleration and these high-frequency, reciprocal inverse thrusts generate shear forces between the layers, which continue in different material-specific directions. The fluid (gas-liquid mixture) considerably reinforces these opening effects.

If the shear forces exceed the binding forces of the assembly, the latter is subsequently opened.

This process is realized by the device according to the invention (reactor 1) represented in FIG. 7. The operation of this device is as follows:

In a reactor 1 there is a vertically arranged rotating part (rotor) 3, which can be raised to a peripheral speed of up to 300 m/s by the drive 4. The mixture of solid matter (composite materials) and fluid, preconditioned in the injection mixer 5a, is subjected to tribomechanical and mechanochemical conditions between the rotor tools 6 and stator tools 7 of different characteristics, in which the composite material dissolves or delaminates. The adjustable curved disc 8 causes a targeted acceleration and deflection of the mixture into the contact area (annular space 10) between the rotor 3 and the stator 2. After the breakdown, the mixture is removed from the reactor 1 and conveyed to the material discharge system 9.

On the path from entry to exit of the reactor 1, the different materials introduced exhibit, due to their different physical properties such as density, elasticity, ductility and surface condition, a very different impact time or dwell time in the reactor 1 from each other. The heavy fractions of the mixture remain only briefly in the annular space 10, while the lighter fractions of the mixture exhibit a longer dwell time. When a metal particle is released after the digestion, its “conveying spiral” through the annular space 10 (resulting from a superposition of its falling movement under the influence of gravity and a circular movement imposed by the rotor 3) changes, which results in a change in the dwell time of the metal particle in the annular space 10. These broken apart metal particles can thus be withdrawn from any further mechanical stress in the annular space 10 and be discharged immediately. This allows a considerable reduction in wear and an increase in the energy efficiency or throughput in the reactor 1. Furthermore, the dwell time in the reactor 1 can be influenced by the peripheral speed of the rotor 3 on the one hand and by increasing the fluid content and its composition on the other hand.

The impact of the materials in the annular space 10 between the stator 2 and the rotor 3 causes a deformation and a balling up of materials such as metals due to their ductility, whereas elastic materials, such as plastics or rubber, are hardly modified, as they absorb the majority of the shocks, vibrations and shock waves. Mineral materials are pulverized due to their brittleness. After the process, the mixture is available in particles of different sizes, specific to each material.

The brittle parts are transformed into fine particles, the metals into reshaped sphere-like layers and the elastic components into flake or chip forms.

The total range of the particle size distribution goes from a few micrometers to the size of the provided input, i.e., the feed size, typically 15 mm. Within this range, the materials are enriched differently, according to normal distributions.

It is now useful to subject this broken apart mixture to classification or sorting. However, it has been shown that due to the dust problem, the materials should preferably be separated in a wet process. Furthermore, it is generally not necessary to dry the mixture in the material stream to be discharged from the reactor, as the subsequent separation takes place in a wet environment anyway. Nevertheless, dryers can be installed optionally downstream of the reactor outlet.

Additional optional separator stations (in particular water separation tables) connected downstream of the reactor outlet allow a multitude of individual fractions to be produced in a single step. The density and buoyancy behavior of the materials are then used.

In the case of broken down electronic printed circuit boards, the following fractions are obtained:
<50 μm mineral components containing rare earth metals
<200 μm Precious metals
100-500 μm Copper and copper metals, or other heavy metals
1 mm aluminum or aluminum alloys
<300 μm Mineral substances Si compounds
500 μm Plastics

It appears from literature that in WO 2006/117065A1, a similar device is to be used for the same purpose, the breaking apart of the composite materials being effected by the stalling of a transport fluid, in this case ambient air, and the composite material thus inevitably undergoing breakdown. The transport fluid (air) is fed to the material to be broken apart in the opposite direction, i.e., against the material stream and gravity. Moreover, this air is absolutely necessary for the breaking apart of the material and for maintaining the turbulences. Likewise, this air flow is used to dissipate the heat produced.

Comminution as described in WO 2006/117065 A1 is precisely not the aim of the present invention. The broken down materials (layers) are not to be crushed.

The application of ambient air, against the material flow and gravity, is then not necessary.

The novelty and inventiveness lie in the fact that the digestion is not effected by means of pulverization, comminution or an acceleration caused by turbulences or other. The digestion is done by mechanochemical and tribomechanical effects caused by the mixture of gas with water (fluid) and the input material (composite material) by the impact on the rotor and stator elements.

In principle, in the device according to the invention, working gases and/or working liquids acting on the materials to be opened and reacting chemically with them can also be added optionally to improve the yield or speed when opening the material stream to be processed.

But a decisive advantage of the present invention is precisely that the device according to the invention can achieve a sufficient degree of efficiency for a large number of composite materials to be opened, by purely physical processing steps alone, only by adding water and conditioned ambient air, so that it is in principle possible to completely dispense with a complex and costly provision of special chemicals (and their subsequent possibly also very complex and costly disposal).

### LIST OF REFERENCE SIGNS

1 reactor
2 stator
3 rotor
4 drive
5 material inlet (injector-mixer 5a, feed hopper 5b)
6 rotor tools
7 stator tools
8 curved disc
9 material outlet
10 annular space

1. A device for breaking down a material stream to be fed, constituted of composite materials and form-locking structures containing composite materials, as well as their mixtures, into individual fractions of the composite materials, the device comprising:
a rotor and a stator inside a reactor, which can rotate relative to one another and which define between them an annular space in which the material stream to be fed can be mechanically broken apart by the cooperation of rotor or stator tools mounted on the rotor or on the stator,
a drive unit for driving the rotor,
a material inlet for bringing the material stream to be fed into the interior of the reactor,
a material outlet for discharging a material stream mechanically broken apart between the rotor and stator and to be discharged from the interior of the reactor,
wherein the material inlet into the interior of the reactor is designed as an injector-mixer in which the material stream to be fed can be supplied with a fluid and mixed, and
wherein a curved disc is placed between the injector-mixer on the one hand and the rotor and the stator on the other hand inside the reactor, in order to deflect in a targeted manner the material stream to be fed by the injector-mixer into the annular region between the rotor and the stator.

2. The device according to claim 1, wherein the distance between the curved disc and the injector-mixer is adjustable.

3. The device according to claim 1, wherein a plate crusher is connected upstream of the injector-mixer in the material stream to be fed, the plate crusher being provided with two or three pairs of plates, each pair of plates comprising respectively a fixed plate and a plate movable relative to it in a substantially perpendicular direction for crushing the material stream to be passed between the plates.

4. The device according to claim 1, wherein lifting magnets, induction separators and/or multi-sensor separators are mounted upstream of the injector-mixer in the material stream to be fed.

5. The device according to claim 1, wherein shredders, hammer mills and/or granulators for comminuting and homogeneously mixing particles are mounted upstream of the injector-mixer in the material stream to be fed.

6. The device according to claim 1, wherein a cyclone or a Venturi mixer is connected downstream of the material outlet of the reactor to mix the material stream to be discharged there with a stream of a working gas, in order to cause a separation of the particles in the material stream to be discharged into one or more fractions, utilizing the different mobilities of the particles in the material stream to be discharged relative to this working gas, due to differences in density and particle sizes.

7. The device according to claim 1, wherein at least one flotation tank and/or at least one hydrocyclone is connected downstream of the material outlet in the material stream to be discharged, said at least one flotation tank and/or said at least one hydrocyclone being adapted to separate into fractions particles from the material stream to be discharged from the interior of the reactor, said particles having densities lower than the predetermined density of working fluids to be added.

8. The device according to claim 1, wherein at least one water separation table, which can be vibrated and is provided with an inclinable working surface, is connected downstream of the material outlet in the material stream to be discharged, said at least one water separation table being adapted to perform a separation of the particles in the material stream to be discharged into one or more fractions utilizing the different mobilities of the particles in the material stream to be discharged due to differences in density and particle sizes.

9. The device according to claim 1, wherein a dryer is connected into the material stream to be discharged after the material outlet from the reactor.

10. The device according to claim 1, wherein a blower is connected into the material stream to be discharged to extract the material stream pneumatically from the reactor.

11. A method for breaking down a fed material stream of composite materials as well as form-locking structures that contain composite materials, and their mixtures, into individual material components, in a device according to claim 1, wherein the fed material stream is mixed with a transport fluid (liquid-gas mixture) in the injector-mixer of the device.

12. The method according to claim 11, wherein the breakdown of the fed material stream is performed according to the following parameters: 2 to 5 volume units of composite solid matter, 1.2 to 1.5 volume units of liquid, preferably water, and 5000 to 12000 volume units of gas, preferably conditioned ambient air.

13. The method according to claim 11, wherein the gas is conditioned ambient air which has been dedusted and whose temperature and humidity have been adjusted in a controlled manner.

14. The method according to claim 11, wherein the heat dissipation is effected by the transport fluid during the breaking apart of the material stream to be fed inside the reactor.

15. The method according to claim 11,
wherein particles in the material stream to be discharged from the material outlet, which have a density that is greater than the density of a working liquid to be fed into the material stream, are suspended in this working liquid and are fed to water separation tables, where fractions of the fragments are respectively precipitated as sediment from the suspension by means of the water separation tables, and/or
a separation into plastics, aluminum and other light metals, copper, copper alloys, precious metals and/or enriched rare earth metals is performed, and this by means of a separation based on the combination of the different densities of the particles in the material stream to be discharged and the vibratory excitation of an inclined plane of a water separation table, which utilizes the different mobilities of the individual particles in the material stream to be broken down, and/or
the mixture is pneumatically conveyed to a gas cyclone and/or a filter, gas, in particular air, is extracted, and liquid, in particular water, is added, so that a suspension is formed, the suspension being treated in a flotation tank and/or on a water separation table and/or a hydrocyclone, in order to separate individual fractions in the suspension from one another.
